(19) United States
(12) Patent Application Publication
(10) Pub. No.: US 2008/0152580 A1
(43) Pub. Date: Jun. 26, 2008

(54) Apparatus And Method Of Producing Chlorine Dioxide

(76) Inventor: Gregory D. Simpson, Seabrook, TX (US)

Correspondence Address: Armstrong, Kratz, Quintos, Hanson & Brooks, 502 Washington Avenue, Suite 220, Towson, MD, 21204, US

(21) Appl. No.: 11/667,746

(22) PCT Filed: Nov. 21, 2005
(86) PCT No.: PCT/US05/42036

§ 371 Date: May 14, 2007

Related U.S. Application Data
(60) Provisional application No. 60/630,409, filed on Nov. 23, 2004.

(51) Int. Cl. C01B 11/02; B01J 19/00

(52) U.S. Cl. 423/477; 422/189

(57) ABSTRACT

A method for producing chlorine dioxide at rates of from a few pounds per day to several hundred pounds per day. A very simple, fixed capacity, educator-based (3) chlorine dioxide generator with booster pump (2) which provides a constant and precise motive water flow through the educator (3). The mixing of precursors is accomplished by educator vacuum pulling the precursors together through separate, but identical fixed diameter flow restrictors (9-10). Precursors flow together in a specified manner and into a reaction column (5) occupied by a static mixer (11) to provide more intimate mixing. Production of small quantities is accomplished by operating the generator in a pulsed mode, via a timer (1).

### BACKGROUND OF THE INVENTION

Chlorine dioxide (ClO2) is an oxidizing chemical with unique properties. Because of its high solubility in water and its effectiveness as a disinfectant, it has been used historically as an aqueous disinfectant or oxidant in a great many applications. It is used in potable water as a preoxidant for trihalomethane (THM) control. THMs are carcinogenic compounds which are normally produced by reaction of chlorine with certain naturally occurring organic compounds such as humic and fulvic acids. When pure aqueous chlorine dioxide is used instead of chlorine, only oxidation occurs; no THMs are produced directly by chlorine dioxide.

Chlorine dioxide is used to prevent control, and mitigate infestations of certain aquatic organisms such as zebra mussels, Asian clams, or other troublesome macro organisms that can impede water flow.

Because of its selectivity, chlorine dioxide is used for destruction of oxidation of some objectionable materials such as phenols, uncomplexed or weakly bound cyanides, hydrogen sulfide (H2S), mercaptans, and other reduced sulfur compounds.

The selectivity of chlorine dioxide is also a major reason for the recent move away from chlorine and toward chlorine dioxide as a pulp bleaching compound in the paper industry. When chlorine is replaced by chlorine dioxide as a bleaching agent, the concentrations of environmentally objectionable compounds such as dioxins and furans found in the plant effluent are generally reduced to concentrations that are below the detectable level. In addition, the nature of any chlorinated organics produced change from hydrophobic to hydrophilic, making the effluent much less harmful to the aquatic environment in that these chlorinated organics do not accumulate in the fatty tissue of fish or other aquatic life.

Chlorine dioxide is used in the oil patch, to stimulate well production, to improve injectivity of disposal wells and to reduce plugging of various pitfield equipment by dissolving or removing anaerobic bacterial biofilm and FeS deposits.

Because of its biofilm penetrating, preventing and removing properties, chlorine dioxide is seeing increasing use in open recirculating cooling systems for control of biofilm, a material produced by bacteria that is corrosive, thermally insulating, and which provides a haven for various pathogenic bacteria such as Legionella.

Due to the exceptional performance characteristics of chlorine dioxide, the small cooling system market is an ideal end use application for chlorine dioxide. Its unique ability to control pathogenic organisms such as Legionella pneumophila, the cause of Legionnaires' disease, is a major reason.

Chlorine dioxide has, until the past few years, seen little use as a gaseous disinfectant. Recently it has seen use as a gaseous disinfectant in certain food applications, in fumigation applications, in toxic mold remediation, and for the successful sterilization of buildings contaminated with biological warfare and terrorism agents such as anthrax spores. In short, chlorine dioxide is a potent bactericide, virucide, protocide, algaecide, and sporicide.

Chlorine dioxide is a gas at ambient temperatures and pressures. Attempts to compress the gas have resulted in energetic decomposition with the associated rapid unscheduled disassembly of compression equipment. As the vapor pressure of chlorine dioxide increases above about 60 mm Hg, the chlorine dioxide can undergo an auto decomposition reaction. The rapid decomposition at this low pressure is referred to by those skilled in the art as a “puff” in that a relatively small amount of energy is released. As the partial pressure increases, the violence of the decomposition reaction increases significantly.

Though chlorine dioxide gas is very soluble in water, it does not react with water to any significant degree, so any agitation of the solution will result in chlorine dioxide being released from solution. As a result, chlorine dioxide is never shipped as an aqueous solution; it must be made on site at the point of use.

The relationship between the partial pressure of chlorine dioxide, the concentration of chlorine dioxide in solution, and temperature are well characterized. Thus, by operating below a given temperature and controlling the concentration of chlorine dioxide in solution, the amount of chlorine dioxide in the vapor can be kept at a safe level. Although aqueous chlorine dioxide solutions can be made safely at substantially higher concentrations, it is customary to control the concentration of chlorine dioxide in aqueous solution to a maximum of about 3500 mg/L, thus virtually eliminating the potential of an energetic decomposition. This information is used by manufacturers in the design and production of chlorine dioxide generation equipment. Although this equipment is essentially an efficient mixing and dosing system, the equipment has been referred to historically by those skilled in the art as a “generator”.

For the purposes of this discussion, production of chlorine dioxide is separated into three production capacity ranges. Large scale production is defined herein to be chlorine dioxide production of greater than 1 ton per day. Although chlorine dioxide can be made by either the oxidation of chlorite ion or the reduction of chlorate ion, chlorate-based generation chemistries have generally been reserved for applications which require large-scale production, which include primarily pulp bleaching.

Moderate scale production is defined herein to be chlorine dioxide production of greater than 30 pounds per day, but less than 1 ton per day. For moderate scale production chlorite-based generation chemistries have been used exclusively in the past. The chlorate process for moderate scale production has historically proved difficult and until only recently has a safe and reliable chlorate-based generation been introduced for production of moderate scale quantities of chlorine dioxide (U.S. Pat. No. 5,376,350).

Small scale production is defined herein to be chlorine dioxide production of less than about 30 pounds per day. Several technologies for chlorine dioxide production are being marketed into the small market, but such equipment has not seen widespread use. These technologies include electrolysis (U.S. Pat. No. 6,274,009), ultraviolet activation (U.S. Pat. No. 6,171,558), acid-chlorine (Prominent, AllDos), ion exchange (Halox), and ion exchange which utilizes acid-chlorite technology (Dripping Wet Water). Although some methods of chlorine dioxide production utilize one or more solid precursors (U.S. Pat. No. 6,197,215 and U.S. Pat. No. 6,602,442), no generation equipment which utilizes this chemistry has been commercialized.

It is the chlorine-chlorite chemistry that is most commonly used in the small scale to moderate production of chlorine dioxide. This chemistry is desirable in that the reaction rate is the most rapid of the chemistries used in small and moderate scale production of chlorine dioxide and very high reactor efficiencies can be achieved in conventional chlorine-chlorite generators, making this chemistry the most economical to small scale production.

The chemistry of the chlorine-chlorite reaction is shown in Equation 1, and from the perspective of the chemistry it does not matter whether the chlorine is provided in gaseous form or is produced from the reaction of acid and bleach.

Cl2+2NaClO2>2ClO2+2NaCl (1)

In this reaction 1 molecule of chlorine dioxide is produced for every molecule of sodium chlorite. The primary design consideration of a chlorine dioxide generator should be to provide sufficient control of precursor flows and to provide mixing of these precursors in a safe manner to insure that the reaction efficiency is as near as possible to 100% and thus maximize the use of the most expensive precursor, sodium chlorite. Once the goal is accomplished, other design considerations such as maintenance, user friendliness, and degree of automation is considered.

The most inherently safe chlorine dioxide generations are those where the reaction of precursors to produce chlorine dioxide occurs under vacuum. That is, they use the motive water passing through an eductor to create a vacuum whereby chlorine dioxide—generating precursors such as acid, bleach, and chlorite are pulled together in a precise way to maximize production of chlorine dioxide. To accomplish this requires design features that allow precise control of precursor flow and promote efficient mixing. These features include expensive and precise rotometers, needle valves, eductor blocks, reaction columns and control electronics.

Current eductor based generator designs most commonly use aqueous solutions comprising about 15% hydrochloric acid, 12-12.5% sodium hypochlorite (bleach) and 25% sodium chlorite. Each precursor has a rotometer that is adjusted to provide the optimal amount of each precursor to maximize the reaction efficiency.

A major drawback of all of these generators is that as the required amount of chlorine dioxide decreases, the reliability of the rotometer used to control pressure flow decreases significantly. This means that for small chlorine dioxide production rates of a few pounds per day, significant losses in efficiency occur. For those skilled in the art, a specific term has been developed which illustrates this phenomenon. This term is called the “turn-down ratio” and it refers to the lowest production rate, when compared to the maximum production rate of a specific generator design, that can be achieved and still meet a given performance standard. The consequence is that a conventional high efficiency eductor-based three-chemical chlorine dioxide generator suitable for a very small application does not currently exist.

Still another drawback of conventional eductor based generators is that in order to insure that a safe chlorine dioxide concentration is produced, the size of the eductor, rotometer, and even pipe diameter can vary with target dosages, eductor motive water flow rates and desired chlorine dioxide production rates.

Some designs incorporate a tank, which receives the generated chlorine dioxide solution. In such designs, the chlorine dioxide generator produces a dilute aqueous solution of chlorine dioxide, typically 1000-3000 mg/L in concentration, into the tank. Then, the ClO2 solution is metered out of the tank to the desired application. While this is a technically sound way of making and dosing chlorine dioxide into very small applications the method suffers from substantial cost issues, in that not only is a generator required, but a sealed tank with appropriate level control instrumentation with redundancy is required for safety. In addition, equipment is required to meter out the dilute chlorine dioxide solution to the point of use. Thus, while equipment exists to make and dose chlorine dioxide is small applications, the high equipment costs result in the end user selecting much less effective, but lower cost alternatives, even when it is clear that chlorine dioxide is by far the preferred disinfectant for the specific application.

Thus, there is a need in the marketplace for a safe, simple, reliable and relatively inexpensive chlorine dioxide-producing methodology that is suitable for very small applications of only a few pounds per day.

The present invention relates to the in-situ production of chlorine dioxide. The preferred embodiment comprises a chlorine dioxide generator, which uses fixed flow restrictors instead of costly rotometers to permit precise flows of precursors. To compensate for the inability to make adjustment via expensive rotometers, the concentration of the acid and bleach precursors are adjusted to insure that the flow of each precursor through the fixed flow restrictor provides the correct amount of active ingredient in each precursor to maximize generation efficiency. With this adjustment in precursor concentration, the fixed flow restrictors provide for a constant production at a sufficiently high generation rate at which precise control of precursor flows can be achieved. Thus, a constant production rate of chlorine dioxide is achieved.

The single largest drawback to such a design is the degradation of bleach which is known to occur. For applications which require relatively large doses of ClO2, use of bleach will generally be at a rate where significant degradation is not likely to occur as bleach is replenished with some frequency. For smaller applications, one solution to this problem is to use diluted precursors, as degradation of bleach is known to be a function of initial bleach concentration. For example, 12% bleach can lose 1% or more of its activity within a week or so depending primarily on temperature, while the rate of degradation of commercially available bleach products frequently found in grocery stores, i.e., 5.25%, is much lower.

Thus, the preferred embodiment incorporates a range of commercially available chlorite precursors of various concentrations with the corresponding concentration of the bleach and acid required to produce the requisite amount of ClO2 through the fixed flow restrictor.

Because the present invention is a fixed capacity generator, generator design does not accomplish alone the desired goal of providing precise small doses to small systems. To accomplish the desired goal of being able to provide small doses to small systems, a specific method of operation is required. The method involves the efficient generation of ClO2 at a relatively high rate, while the generator operates intermittently in short pulses, allowing small doses of the generated ClO2 to be applied to the target application. The very fast rate of reaction of the precursors allows a pulsed operation of the generation without significant degradation in reaction efficiency. Therefore, the use of a booster pump controls motive water flow through the generator educator so that the generator is allowed to operate for as few as 3 seconds duration every 1 or more minutes. Alternatively, an electrically actuated solenoid valve can replace the pump and control motive water flow, if a source of water with suitable pressure, volume and purity requirements is available. The chlorine dioxide requirements of a specific application will dictate the duration and frequency of treatment. For example, if the flow through the generator is 8 gallons per minute, then operating a 3-4 seconds per minute will allow 3-4/60, or 5-7% of 8 gallons, or about ½ gallon of a 1000-3000 mg/L chlorine dioxide solution to be dosed to a system. This would be analogous to pouring into the basin of a small cooling tower approximately a half gallon of a 1000-3000 mg/L chlorine dioxide solution every minute or two to achieve the desired effect.

It should be apparent to one skilled in the art that the maximum dosage of chlorine dioxide that will be “seen” by the metallurgy of a small cooling tower can be controlled by the frequency and duration of generator operation.

### SUMMARY OF THE INVENTION

The present invention provides a complete chlorine dioxide generating and dosing system which includes an eductor, a fixed flow restrictor reaction column with mixing chamber, device for providing a constant motive water flow, and a timing device to control the frequency and duration of operation.

The generator comprises an eductor that creates a vacuum with motive water flow. To the eductor is attached a reaction column assembly, with the fixed flow restrictors incorporated into the reaction column assembly to insure a predictable, reproducible vacuum at each flow restrictor. Precursors are pulled through these flow restrictors.

These and other objects of the present invention will become apparent from a reading of the following specification taken in conjunction with the enclosed drawings.

### BRIEF DESCRIPTION OF THE DRAWINGS

FIG. 1 shows the arrangement of the eductor with check valve, reaction column assembly, booster pump, and timer.

FIG. 2 shows the arrangement of the eductor with the reaction column assembly, water flow solenoid and timer.

FIG. 3 shows a cross-sectional area and components of the reaction column assembly.

FIG. 4 shows the assembled reaction column with solenoid valves.

FIG. 5 is a graph showing the concentration of chlorine dioxide produced as a function of the volume of bleach.

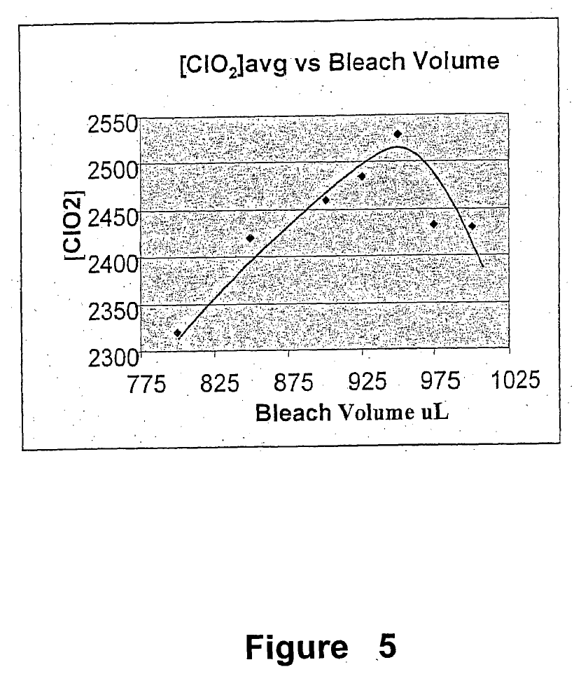

### DESCRIPTION OF THE PREFERRED EMBODIMENTS

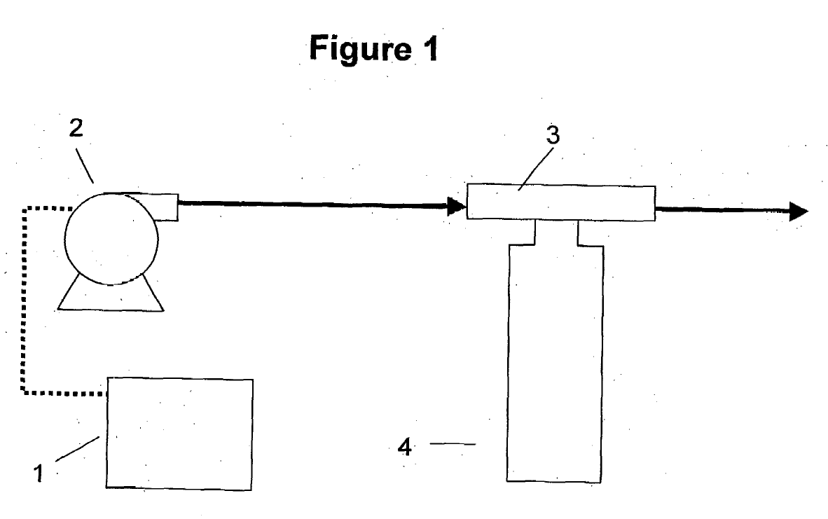

With reference to FIG. 1, the generator comprises a timer 1, a pump 2, an eductor 3 and the reaction column assembly 4.

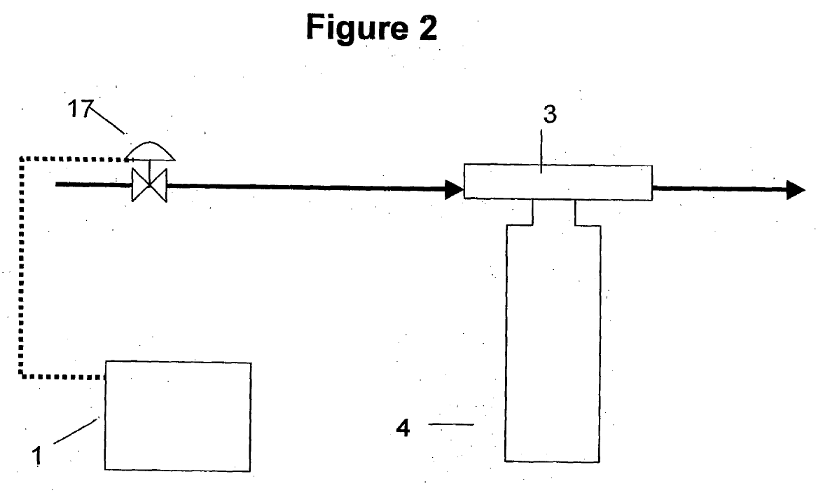

With reference to FIG. 2, the generator comprises a timer 1, a water solenoid valve 17 to permit water flow, should the water have a suitable pressure and flow to drive the eductor, an eductor 3, and the reaction column assembly 4.

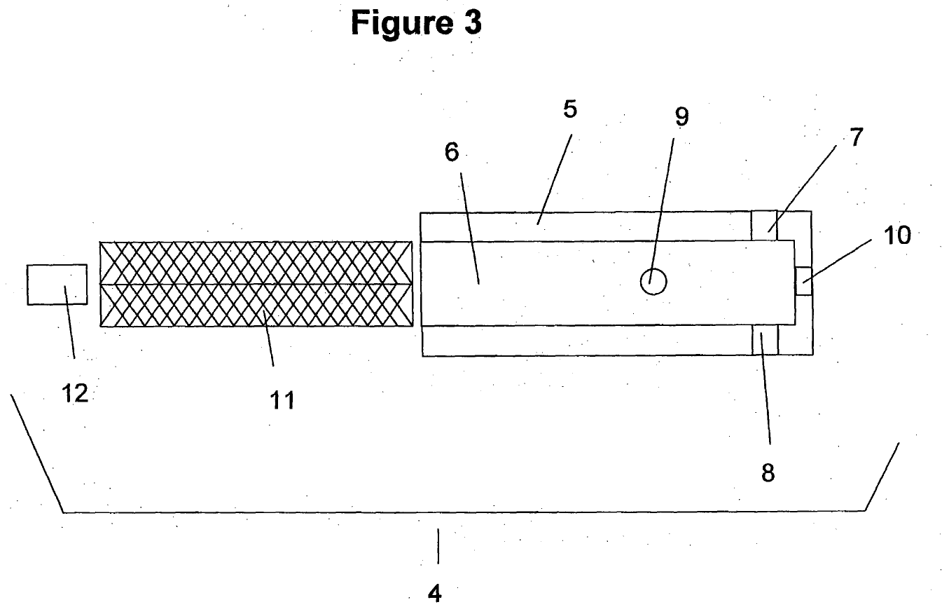

With reference to FIG. 3, the reaction column assembly 4 is shown, comprising the reaction column body 5, threaded holes for the introduction of acid 7, bleach 8, chlorite 9 and the purge water 10, a mixing chamber 6, machined inside reaction column body 5 of about 0.75 inches, inside which resides a static mixer of appropriate diameter 11, and held in place by a screwed or glued fitting 12.

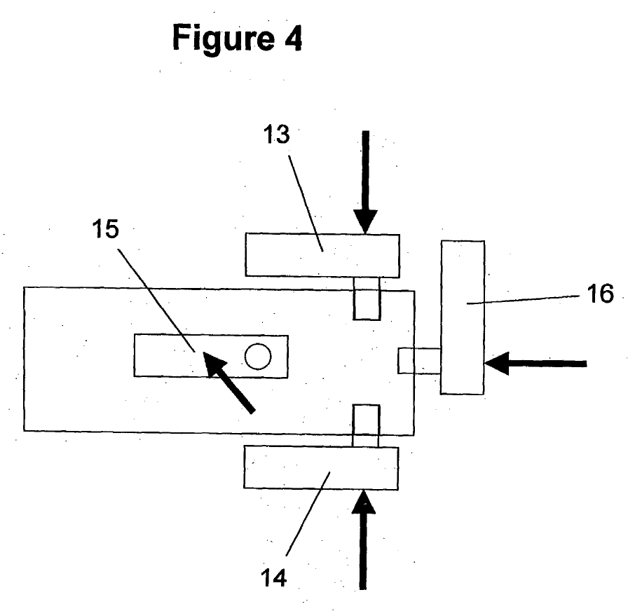

With reference to FIG. 4, three precursor solenoid valves (preferably identical), each incorporating a fixed flow restrictor made of a chemically inert material such as teflon through which a 0.0625 inch hole has been machined to allow precursor flow of acid 13, bleach 14 and chlorite 15, along with a fourth solenoid 16 with a larger hole that has been machined to allow a water flush to remove the ClO2 from the reaction column after each operation of the generator, should the generator be operated in intermittent mode, to eliminate any potential for spill of aqueous ClO2.

The reaction column assembly may be formed from a single machined body.

### General Operation:

With reference to FIG. 1, the timer 1 actuates the pump 2. A constant motive water flow is provided to the eductor 3 which thereby creates a vacuum. Precursors are pulled through the reaction column assembly 4 into the motive water flow.

With reference to FIG. 2, the timer 1 actuates the solenoid valve which controls motive water flow 17. Motive water flow is provided to the eductor 3 which creates a vacuum. Precursors are pulled through the reaction column assembly 4 into the motive water.

With reference to FIG. 3, acid and bleach precursors are pulled through the precursor inlet line holes 7 and 8, through fixed flow restrictors (preferably of identical diameters), and into the reaction column 6, where some mixing occurs. The combined acid and bleach precursor stream is pulled through the mixing chamber wherein lies the static mixer 11 to provide more intimate mixing. As the reaction of bleach and acid occurs very rapidly, the aqueous chlorite precursor is drawn by vacuum through the chlorite inlet line hole 9, through the chlorite fixed flow restrictor which, preferably has the same length and diameter as those of the acid and bleach precursors. At this point the reacted acid/bleach mixture (molecular chlorine) reacts further with the chlorite precursor, moving through the remainder of the mixing chamber, where it is mixed thoroughly by the static mixer 11, and exiting through the outer fitting 12, where it is pulled into the motive water and to the point of use.

The chlorite precursors may be an aqueous solution of alkali metal chlorite including sodium chlorite, potassium chlorite, calcium chlorite, lithium chlorite or magnesium chlorite. The acid precursors, or proton donor, is preferably a mineral acid such as hydrochloric acid, sulfuric acid and nitric acid. The bleach precursors, or chlorine donor, may be sodium hypochlorite, calcium hypochlorite, potassium hypochlorite, lithium hypochlorite, dichloro isocyanuric acid or trichloroisocyanuric acid. Persons skilled in the art may use other precursors.

It is preferred that the fixed flow restrictors incorporated into solenoid valves 13, 14 and 15, have an inside diameter of approximately 0.0625 inches and a minimum length of approximately 0.5 inches. The restrictors must be formed from a material that is resistant to corrosion and swelling by the precursors which flow through the fixed flow restrictors as described herein. The mixing chamber 12 is approximately 4 inches long and has a diameter of approximately 0.75 inches. The static mixer 13 which is received in the mixing chamber is approximately 4 inches long.

### Intermittent Generator Operation:

Because the present invention is a fixed capacity generator, generator design does not accomplish alone the desired goal of providing precise small doses to small systems. To accomplish the desired goal of being able to provide small doses to small systems, a specific method of operation is required. The method involves the efficient generation of ClO2 at a relatively high rate, while the generator operates intermittently in short pulses, allowing small doses of the generated ClO2 to be applied to the target application.

The very fast rate of reaction of the precursors allows a pulsed operation of the generator without significant degradation in reaction efficiency. Therefore, the use of a booster pump controls or interrupts motive water flow through the generator eductor so that the generator is allowed to operate for as few as 3 seconds duration every 1 or more minutes.

Alternatively, an electrically actuated solenoid valve can replace the pump and control or interrupt the motive water flow, if a source of water with suitable pressure, volume and purity requirements is available. At the end of each generation period, the precursor valves close and a fourth solenoid valve 16 (FIG. 4) opens to allow the generated ClO2 solution to be flushed from the system.

As the reaction of acid, bleach and chlorite occurs almost instantaneously, operating the generator in an intermittent manner, i.e., opening the acid bleach, and chlorite solenoid valves for brief periods of time (a second or two) allows small doses of aqueous chlorine dioxide to be generated and applied to a given system, with the generated solution being removed after each generation interval to insure no ClO2 solution remains inside the generator during periods where no generation is being done. For example, for a generator producing 13 gpm of a 1000 mg/L aqueous chlorine dioxide solution, the daily generation rate is calculated to be about 150 lb/day ClO2.

By setting the timer to open the solenoid for 3 seconds every minute allows 3/60=5% of full scale operation. The daily rate of production would then be about 7 lb/day.

It should be apparent to one skilled in the art that the maximum dosage of chlorine dioxide that will be seen by the metallurgy of a small cooling tower can be controlled by the frequency and duration of generator operation.

For a given amount of vacuum, the flow restrictor diameter determines the volume of precursor flow to the reaction column. Small variations in the flow restrictor diameter allow different amounts of precursor to be pulled. Such an arrangement would allow use of the most commonly used preferred precursor concentrations, of 15% HCl, 12.0-12.5% NaOCl (bleach), and 25% sodium chlorite. This arrangement is essentially the same as the conventional chlorite dioxide generators in the market today, where precise control of precursors is accomplished by adjustment of the needle valve associated with the precision rotometers.

Alternatively, and the preferred embodiment of this invention, is the use of identical diameter fixed flow restrictors. For a given flow restrictor diameter, the relative volume of each precursor pulled varies as a function of the viscosity of each precursor. By accounting for viscosity differences, the concentration of the bleach and acid can be adjusted to insure that the correct amount of each precursor is withdrawn through its flow restrictor. The correct amount of acid and bleach is that required to react with the amount of aqueous sodium chlorite that is withdrawn through the same size flow restrictor to achieve the stoichiometry given in Equation 1.

The preferred eductor pulls an essentially constant volume of a given precursor over a wide range of motive water flows for constant flow restrictor inlet and back pressure. A pump installed prior to the eductor provides a constant motive water flow. Since the water flowing through the generator eductor into the point of application can be selected to have minimal back pressure, the desired concentration of chlorine dioxide in aqueous solution can be controlled.

Still, the flow restrictor-based generator alone has fairly limited utility in that a constant high level production of aqueous chlorine dioxide is achieved, and as such would not be suitable for use in very small applications, because high levels of chlorine dioxide can be quite corrosive. The very fast reaction rate of the chemical precursors to produce chlorine dioxide allows the generator to be operated in an intermittent mode. This allows significant reductions in the amount of chlorine dioxide produced over time.

### Experiment 1

The optimum dosage of each precursor was investigated in 70 ml of water, 1 ml of 25% sodium chlorite was added and volumes of 12% bleach was varied, acid being added to adjust the pH to 2.5-3.0, to determine optimum amount of bleach.

The results are shown in FIG. 4.

It is clear from the graph that the maximum production of chlorine dioxide is achieved at a volume of 95% of that of the precursor sodium chlorite. From this value, the concentration of bleach required to provide an equivalent amount of sodium hypochlorite was computed to be about 11-12%. The efficiency of reaction in beakers was surprisingly found to be about 76%, which is exceptional considering the non-ideal circumstances.

Then, in a similar manner, the amount of 22° Bé hydrochloric acid (35% HCl) required to reduce the pH to a range of 2.5-3.0 was measured.

The preferred embodiment includes precursors which comprise 25% sodium chlorite, 11-12% sodium hypochlorite, and 9-13% hydrochloric acid. The range for hydrochloric acid is somewhat larger than for bleach. The reason for this is that in bleach manufacture there is quite a bit of variability from manufacturer to manufacturer of the excess caustic in bleach. This can vary from 0.2 wt % to 2 wt % excess caustic and so the amount of acid required to neutralize this excess caustic will also vary as the source of bleach varies. In addition, for this reaction, ClO2 production is less sensitive to pH than to the bleach/chlorite ratio.

Obviously, many modifications may be made without departing from the basic spirit of the present invention. Accordingly, it will be appreciated by those skilled in the art that within the scope of the appended claims, the invention may be practiced other than has been specifically described herein.

1. An apparatus for the generation of chlorine dioxide comprising:
a reaction column assembly having a first end and an opposite second end, the first end being connected to an eductor, means to provide a constant motive water flow to an inlet of the eductor thereby creating a vacuum at the first end of the reaction column assembly,
a first fixed flow restrictor and a second fixed flow restrictor formed in the second end of the reaction column assembly, a reaction zone in the reaction column assembly communicating with the first and the second fixed flow restrictors, the reaction zone connected to a first end of a mixing chamber within the reaction column assembly, a third fixed flow restrictor communicating with the mixing chamber, a static mixer disposed on the mixing chamber, an outlet fitting formed in the second end of the mixing chamber, the outlet fitting being connected to the eductor,
a supply of a predetermined concentration of an aqueous solution of acid connected to the first fixed flow restrictor, a supply of a predetermined concentration of an aqueous solution of bleach connected to the second fixed flow restrictor, a supply of a predetermined concentration of flow aqueous solution of chlorite connected to the third fixed flow restrictor, with each fixed flow restrictor having a predetermined orfice diameter in relation to vacuum produced by flow of motive water to determine the respective volume of precursor to flow to the reaction column,
wherein vacuum produced by flow of motive water through the eductor causes the aqueous solutions of acid and bleach to flow at a respective predetermined, controlled rate through the first and second fixed flow restrictors, the solutions of bleach and acid reacting in the reacting zone to form chlorine, the chlorine so formed passing into the mixing chamber and reacting with the aqueous solution of chlorite to produce chlorine dioxide, the produced chlorine dioxide being drawn out of the outlet fitting into the solution and being carried by the motive water flow to a point of use,
the concentrations of the aqueous solution of acid, bleach and chlorite being predetermined by the orfice diameter of the respective first, second and third fixed flow restrictors.

2. The apparatus of claim 1, further having a means to interrupt the constant motive water flow wherein the apparatus may be activated for a selected interval of time to generate a desired amount of chlorine dioxide.

3. The apparatus of claim 2, wherein the selected interval of time may vary from seconds to minutes to continuous, uninterrupted operation.

4. The apparatus of claim 2, wherein the means to interrupt the constant motive water flow is a timer.

5. The apparatus of claim 2, wherein the means to interrupt the constant motive water flow is an electrically actuated solenoid.

6. The apparatus of claim 1, further having a check valve connected to the eductor to prevent back flow.

7. The apparatus of claim 1, wherein the first, second and third fixed flow restrictors, each have an inside diameter of approximately 0.0625 inches.

8. The apparatus of claim 1, wherein the first, second and third fixed flow restrictors are formed from a material that is resistant to corrosion and to swelling by acid, bleach and chlorite solutions.

9. The apparatus of claim 1, wherein the concentrations, by volume, of the aqueous solutions are approximately:

| | |
|---|---|
| bleach | 11-12% |
| acid | 9-13% |
| chlorite | 25% |

10. A generator for aqueous solutions of chlorine dioxide comprising:
a means for producing a constant motive water flow connected to a reaction column assembly such that vacuum is drawn through the reaction column assembly,
the reaction column assembly having:
(a) a first inlet connected to a first fixed flow restrictor such that the vacuum pulls therethrough an aqueous solution of a proton donor at a first fixed rate,
(b) a second inlet connected to a second fixed flow restrictor such that the vacuum pulls therethrough an aqueous solution of a chlorine donor,
(c) the first and second restrictor communicating with a reaction zone wherein the solution of proton donor reacts with the solution of chlorine forming a reaction product, the reaction product being drawn into a mixing chamber,
(d) a third inlet connected to a third fixed flow restrictor such that the vacuum pulls therethrough an aqueous solution of chlorite wherein the aqueous solution of chlorite reacts with the reaction product forming the aqueous chlorine dioxide which is pulled into the motive water with each fixed flow restrictor having a predetermined orfice diameter in relation to vacuum produced by flow of motive water to determine the respective volume of precursor to flow to the reaction column.

11. The generator of claim 10, wherein the first, second and third fixed flow restrictors each have an inside diameter of approximately 0.0625 inches.

12. The generator according to claim 10, which uses an effective amount of the aqueous solution of the proton donor, the aqueous solution of the chlorine donor and the aqueous solution of the chlorite.

13. The generator of claim 12, wherein the effective amounts by volume of the aqueous solutions are approximately:

| | |
|---|---|
| proton donor | 9-13% |
| chlorine donor | 11-12% |
| chlorite | 25% |

14. The generator according to claim 10, wherein the proton donor is a mineral acid, and is selected from the group comprising hydrochloric acid, sulfuric acid, nitric acid and the like.

15. The generator according to claim 10, wherein the chlorine donor is selected from the group comprising sodium hypochlorite, calcium hypochlorite, potassium hypochlorite, lithium hypochlorite, dichloro isocyanuric acid or trichloro isocyanuric acid.

16. The generator according to claim 10, wherein the chlorite is selected from the group comprising sodium chlorite, potassium chlorite, calcium chlorite, lithium chlorite or magnesium chlorite.

17. The generator of claim 10, wherein the diameter of the respective first, second and third fixed flow restrictor is selected to allow specific rates of the corresponding aqueous solutions to be drawn into the respective fixed flow restrictor to maximize production of chlorine dioxide.

18. A method of producing chlorine dioxide comprising the steps of:
providing a reaction column assembly having a first, a second and a third inlet, each inlet being connected to a fixed flow restrictor, the restrictors being in communication with one another,
connecting an aqueous solution of acid to the first inlet, connecting an aqueous solution of bleach to the second inlet, connecting an aqueous solution of chlorite to the third inlet,
connecting a source of vacuum to the reaction column wherein the aqueous solutions are drawn through the respective fixed flow restrictors, the flow rate of each solution being controlled by the respective fixed flow restrictors, the aqueous solutions reacting to produce the chlorine dioxide,
and wherein each fixed flow restrictor has a predetermined orfice diameter in relation to vacuum produced by flow of motive water to determine the respective volume of precursor to flow to the reaction column, thus, the concentrations of each aqueous solution being an effective amount selected for maximum efficiency of reaction as controlled by the flow rate through the respective fixed flow restrictors.

19. The method of claim 18, further comprising the connecting of an adjustable timer to the source of vacuum such that pulsed operation can be produced, the frequency and duration of the pulse being variable.

20. The method of claim 18, further comprising an electrically activated solenoid connected to the each the first, second and third inlet thereby controlling the introduction of the aqueous acid, the aqueous bleach and the aqueous chlorite into the reaction column assembly.
